(19) United States
(12) Patent Application Publication
(10) Pub. No.: US 2004/0074668 A1
(43) Pub. Date: Apr. 22, 2004

(54) Cable for minimizing skew delay and crosstalk

(76) Inventor: Steve Somers, Chino Hills, CA (US)

Correspondence Address: The Hecker Law Group, Suite #2300, 1925 Century Park East, Los Angeles, CA, 90067, US

(21) Appl. No.: 10/439,365

(22) Filed: May 16, 2003

Related U.S. Application Data
(60) Provisional application No. 60/418,864, filed on Oct. 16, 2002.

(51) Int. Cl. H01B 7/00

(52) U.S. Cl. 174/113 R

(57) ABSTRACT

A cable with minimum skew for analog video and minimum crosstalk for data transmission is presented. A UTP cable of the present invention has conductors with nearly identical electrical lengths while providing minimum crosstalk between the conductors in the cable bundle. The electrical lengths of the conductors are sufficiently equal to allow use for analog video networks without undue equalization. In addition, the construction methodology results in a cable with minimum crosstalk thereby providing a cable similar in characteristics with prior art UTP cables used for data networks.

### CROSS REFERENCE TO RELATED APPLICATIONS

This non-provisional application claims priority of U.S. Provisional Application No. 60/418,864 entitled “CABLE FOR MINIMIZING SKEW DELAY AND CROSSTALK DURING THE TRANSMISSION OF DIGITAL OR ANALOG SIGNALS”, filed on Oct. 16th, 2002, specification of which is herewith incorporated by reference.

### BACKGROUND OF INVENTION

1. Field of the Invention

This invention relates to the field of signal transmission. More specifically, invention relates to transmission of data and video over Unshielded Twisted Pair (UTP) cables.

2. Background Art

Data networks, or local area networks (LANs), typically use low cost unshielded twisted pair (UTP) wire for bi-directional communication of digital data. In addition, special application UTP may convey analog video signals over a dedicated video-type network. In both cases, the current constructions of UTP wherein four twisted pairs are utilized, involve manipulation of the twisted pairs such that each pair has a different twist rate and maintains the same twist rate throughout the cable length so as to minimize crosstalk of data signals between pairs.

FIGS. 1A and 1B illustrate the construction of a prior art Unshielded Twisted Pair (UTP) cable for data transmission. As illustrated in FIG. 1A, a typical UTP cable 100 comprises four twisted pair wires 104,106,108, and 110, all located within a cable bundle. The bundled twisted pair wires are held together with insulation layer 102. Referring to FIG. 1B, each of the four twisted pairs (e.g. 104, 106, 108 or 110) consists of two wires identified with suffix “A” and “B” and having a specific twist rate. For instance, twisted pair 104 comprises wire 104A and wire 104B having a constant twist rate “A” throughout its length; twisted pair 106 comprises wire 106A and wire 106B having a constant twist rate “B” throughout its length; twisted pair 108 comprises wire 108A and wire 108B having a constant twist rate “C” throughout its length; and twisted pair 110 comprises wire 110A and wire 110B having a constant twist rate “D” throughout its length.

As illustrated, each of the prior art twisted pair cables (e.g. 104, 106, 108, or 110) has a specific twist rate different from the other twisted pairs. All of these twisted pairs, each one made with a specific twist rate, are located side-by-side within a cable bundle. The different twist rates contribute to lowered crosstalk.

Some prior art technologies employ other means to minimize crosstalk (or coupling). For instance, there are UTP cables constructed such that two pairs of the typically four pairs are twisted in a right-hand direction while the remaining two pairs are twisted in the usual left-hand direction. This configuration further minimizes crosstalk between data signals traveling on the cable pairs. UTP data cables used to transmit video signals, suffer from the fact that such data cables are constructed using different twist rates between conducting pairs. This results in each pair having a different electrical length. The differing electrical lengths result in proportional delay of the video signal when applied over the long distances (around 100 meters or more) typically encountered in some application. The differences in electrical lengths are responsible for delays between the components of a video signal. For instance, two of the components (e.g., R and G) in an RGB video signal will be delayed from the third component (e.g. B) by an amount that is proportional to the difference in length between the twisted pair cable carrying the third component (i.e., B) and the twisted pair cables carrying each of the first two components (e.g., R and G).

This delay in each component signal is long enough to create an offset of visual information on a display screen so as to appear misconverged. Thus, graphic details may not properly line up on the screen at the appropriate location. This delay effect makes for poor video quality and sometimes totally unacceptable video performance. To counteract this effect in prior art systems, some form of delay must be added to the shorter pathways (i.e., shorter twisted pairs) in the transmission line to compensate for the delays. Thus, additional circuits are used to add appropriate delays to the faster components so that they will allign with the slowest component.

Various methodologies for correcting delay problems are known. For example, an appropriate length of cable may be added to each of the faster transmission lines to compensate. In addition, various electrical circuit schemes exist for compensating (e.g., delaying) video channels within the processing system that receives the UTP-transmitted information.

One method of solving the delay problem for video applications is to use UTP cables of equal length pairs. However, prior art UTP-type cables with equal length pairs promote cross coupling (cross-talk) of data and thus are not suitable for data networks. In analog video and graphics application, cross coupling is not a prime issue and, since analog video is a one-way transmission application, any cross coupling is usually small enough that a receiver is able to equalize and mostly ignore it. However, since crosstalk is an issue to be considered for data transmission, the requirements for video and data conflict so that a single cable is incapable of performing both tasks. Thus, UTP cabling which might be used for data networks must be wholly dedicated to that application and cannot be used for analog video applications.

In addition, utilization of prior art low-skew UTP cable is appropriate for dedicated installations where prior knowledge of the analog video/graphics system is prescribed. These low-skew UTP cables may be appropriate for analog video but not for data because key cross-talk parameters that are important to data network communications will be severely compromised such that the data network node may not perform at all.

Therefore there is a need for cabling that minimizes delays between components during transmition of analog signals and minimizes cross-talk during transmition of data signals.

### BRIEF DESCRIPTION OF DRAWINGS

FIGS. 1A and 1B illustrate the construction of a prior art Unshielded Twisted Pair (UTP) cable for data transmission.

FIG. 2 is an illustration of four cable segments having different twist rates.

FIG. 3 is an illustration of the construction of a four conductor UTP cable in accordance with an embodiment of the present invention.

FIG. 4 illustrates construction of each pair of an Unshielded Twisted Pair (UTP) cable configured in accordance with embodiments of the invention.

FIG. 5 is an illustration of a UTP cable for data and video transmission in accordance with embodiments of the present invention.

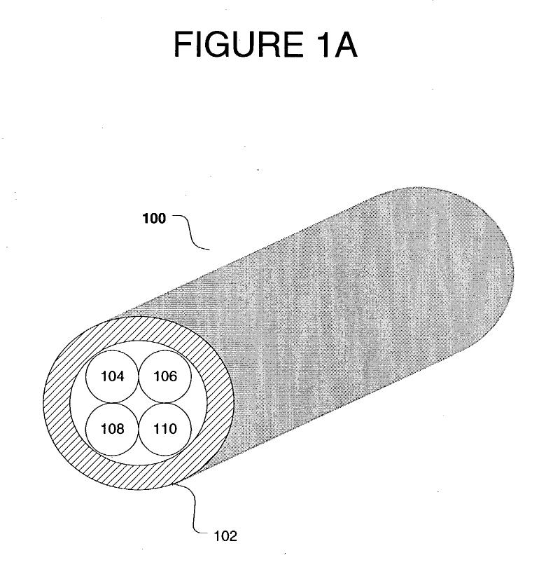

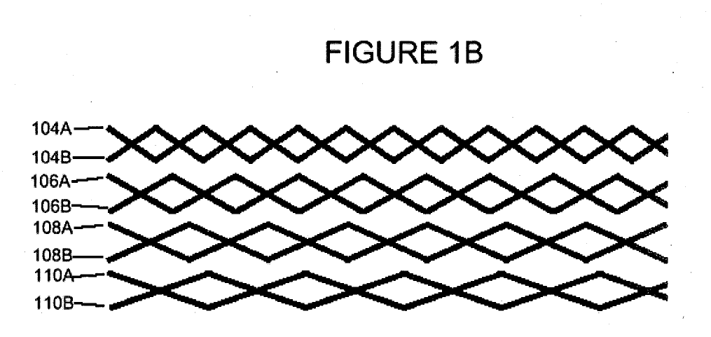

### SUMMARY OF INVENTION

The invention comprises a cable with minimum skew for video and minimum crosstalk for data transmission.

Data networks, or LANs, typically use low cost UTP (unshielded twisted pair) wire for bi-directional communication of digital data. In addition, special application UTP cables may be used to convey analog video signals over a dedicated video-type network. In data transmission, prior art construction of UTP wherein four twisted pairs are utilized, involve manipulation of the twisted pairs such that each pair has a twist rate throughout the cable that is different from the other pairs thus minimizing crosstalk of data signals between pairs.

UTP data cables may be utilized in analog video applications, for example, RGB analog video or graphics. Video use suffers from the fact that UTP data cable construction having different twist rates between conducting pairs results in each pair having a different electrical length. The differing electrical lengths result in proportional delay of the video signal when applied over the long distances (around 100 meters or more) typically encountered in some application. The delay period is long enough to create an offset of visual information on the display screen so as to appear as a convergence problem. Thus, graphic details may not properly line up on the screen at the appropriate location.

An embodiment of the present invention provides a UTP cable having characteristics important to both analog and digital data systems. The UTP cable has complementary properties for data networking while maintaining low skew for analog video transmission.

In one embodiment, a UTP cable having the typical four twisted pair wires is constructed wherein each of the twisted pairs has a prescribed varying twist rate. Fundamental construction of the twisted pairs is the same as for current category style cable pair construction. However, the twist rate is changed on a repetitive basis throughout the length of the twisted pair so that the number of distinct twist rate changes is equal to the number of pairs bundled within the UTP assembly. Further, the initial positioning of each twisted pair with respect to each other pair is offset so that each pair has a “staggered start” in the bundling process. Since each pair has four different twist rates (for a four-pair cable like CAT5) the pairs are staggered at the beginning of the bundling process such that no two pairs have the same twist rate adjacent to the other.

A UTP cable constructed in accordance with embodiments of the present invention results in cables having conductors with nearly identical electrical lengths and minimum crosstalk because of the staggered and varying twist rates. The electrical lengths are sufficiently equal to allow use for analog video networks without undue equalization. In addition, minimum crosstalk gives the cable similar characteristics as prior art constant twist rate network cable designs for data networks.

### DETAILED DESCRIPTION

The present invention teaches a cable construction to minimize skew delay and cross-talk during transmission of analog video and digital data signals. In the following description numerous specific details are set forth in order to provide a more thorough understanding of the present invention. It will be apparent, however, to one skilled in the art, that the present invention may be practiced without these specific details. In other instances, well-known features have not been described in detail so as not to obscure the invention.

A cable constructed in accordance with embodiments of the invention minimizes the delay problem inherent in existing construction methodologies while still minimizing cross-talk. This allows the same cable to be used for transmitting analog and digital data signals, thereby enabling a single type of cable to be installed without concern for the ultimate use.

Embodiments of the invention are directed to a UTP cable that has characteristics important to the transmission of both analog and digital data. Thus, the cabling is effective for independently sending analog or digital signals. The UTP cable constructed in accordance with the invention has complementary properties for data networking while maintaining the low skew required for analog video transmission. This allows the cable to be used for both purposes and thereby saving on the installation and planning costs associated with using different cables for different types of transmission. Thus, with embodiments of the present invention, the dedication of analog video/graphics handling systems may still be mandated, but the cabling could be installed in a building without concern for the final application. In other words, because of the complementary properties of the UTP cable of the present invention, application specific cabling is not necessary.

A UTP cable implementing an embodiment of the invention may have the typical four twisted pair conductors, where each of the twisted pairs has a prescribed and varying twist rate. The twist rate on each conductor changes on a repetitive basis throughout its length with the number of distinct twist rates equaling the number of pairs bundled within the UTP assembly. Further, the initial positioning of each twisted pair with respect to each other pair is offset so that each pair has a “staggered start” in the bundling process. Since each pair has four different twist rates (for a four-pair cable like CAT5) the pairs are staggered at the beginning of the bundling process such that no two pairs have the same twist rate adjacent to the other.

The twist rate offset accomplishes at least two goals: 1) the resultant electrical length of all the pairs in the assembly are essentially nearly identical, except in a condition where the length of cable is less than one complete staggered cycle of the offset construction; and 2) the staggered twist rates minimizes cross coupling between each of the pairs. Within a certain distance, the electrical length will be sufficiently equal to allow use on analog video networks without undue equalization errors. For data networks, the cross-talk is minimized in a manner similar to prior art UTP cable designs having a constant twist rate throughout the length of each conductor.

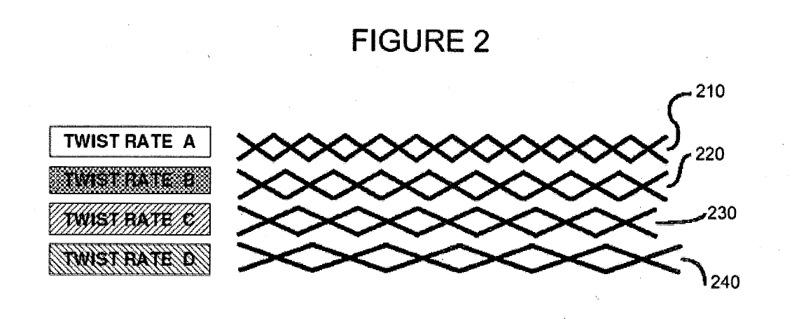

FIG. 2 is an illustration of four cable segments having different twist rates. As illustrated, cable segment 210 has a twist rate of “TWIST RATE A”; cable segment 220 has a twist rate of “TWIST RATE B”; cable segment 230 has a twist rate of “TWIST RATE C”; and cable segment 240 has a twist rate of “TWIST RATE D”. These four deferring twist rates may be applied to an embodiment of the present invention having four twisted pair cables bundled together.

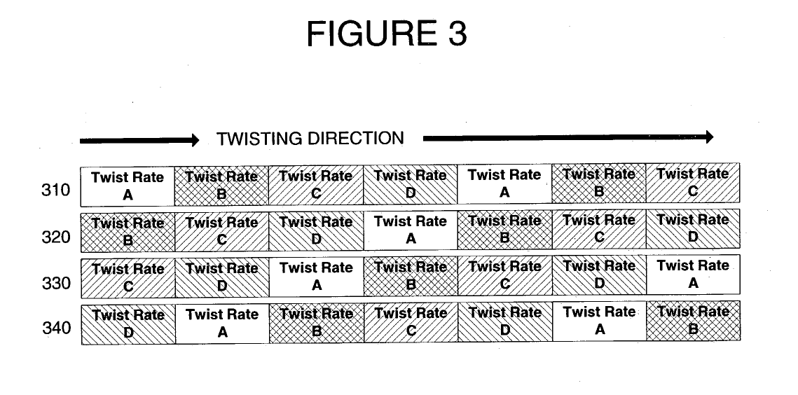

In accordance with the present invention, construction of each twisted pair is such that each pair includes a number of differing rates equal to the number of pairs in the bundle. For instance, in the embodiment having four twisted pair cables bundled together, each twisted pair will have “TWIST RATE A”, “TWIST RATE B”, “TWIST RATE C”, and “TWIST RATE D”. An illustration of a cable construction in accordance with an embodiment is shown in FIG. 3.

FIG. 3 is an illustration of the construction of a four conductor UTP cable in accordance with an embodiment of the present invention. Blocks 310, 320, 330, and 340 illustrate how the different twist rates are applied to each of the pairs of the UTP. Assuming each of blocks 310, 320, 330, and 340 is a twisted pair in a UTP bundle, starting from left to right (i.e., in the direction of the arrow), the cable construction is such that each pair has a segment having a twist rate of “TWIST RATE A”, followed by a segment having twist rate of “TWIST RATE B”, followed by a segment having twist rate of “TWIST RATE C”, followed by a segment having twist rate of “TWIST RATE D”, and repeating the cycle until the end of the cable.

However, for each cable, the starting segment is different. For instance, in this illustration the starting segment for cable 310 has a twist rate of “TWIST RATE A”; the starting segment for cable 320 has a twist rate of “TWIST RATE B”; the starting segment for cable 330 has a twist rate of “TWIST RATE C”; and the starting segment for cable 340 has a twist rate of “TWIST RATE D”. In so staggering the twist rate of the starting segment, the present invention assures that no two adjacent twist rates are identical, and that the manufacture of the UTP cable is not complex.

In the illustration of FIG. 3, all pairs of a UTP cable are created identically with, for example, the first twist rate (e.g. “Twist Rate A”) for some length, then the second twist rate (e.g. “Twist Rate B”) for an equal length, followed by the third twist rate (e.g. “Twist Rate C”) for the same distance, followed by a fourth twist rate (e.g. “Twist Rate D”) for an equal distance. During cable fabrication, the twisting machine is capable of changing twist rate at pre-programmed intervals during the twisting process. The key element is the ability to accurately reproduce the twist rate along the twisted pair at repeating intervals (in this case four intervals) along the cable length. Once this incremental twist rate sequence is in place, all twisted pairs will contain essentially the same twist rates at the same intervals.

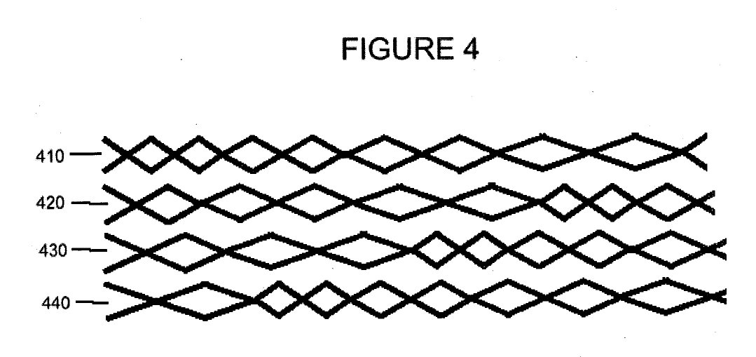

FIG. 4 illustrates construction of pairs of an Unshielded Twisted Pair (UTP) cable configured in accordance with embodiments of the invention. In this illustration a UTP cable design has four twisted pairs (e.g. 410, 420, 430 and 440), with each pair having varying twist rates in accordance with the illustration of FIG. 3. The present illustration shows construction of sample pairs 410, 420, 430, and 440, when the twist rates of FIG. 2 are applied using the method of the present invention. In this illustration each pair uses approximately two segments of twists of the same twist rate for each cable. For instance, each pair (i.e. 410,420,430, and 440) uses two segments of “TWIST RATE A”, two segments of “TWIST RATE B”, two segments of “TWIST RATE C”, and two segments of “TWIST RATE D” thus all the pairs in the UTP cable bundle are of equal length. Therefore, the UTP cable of the present invention has ideal characteristics for analog transmission because of the approximate equality in length of all the conductors in a bundle resulting in a lack of perceptible delay between conductors. Also, since the twist rates are staggered, crosstalk is minimized thus providing characteristics conducive for digital data transmission.

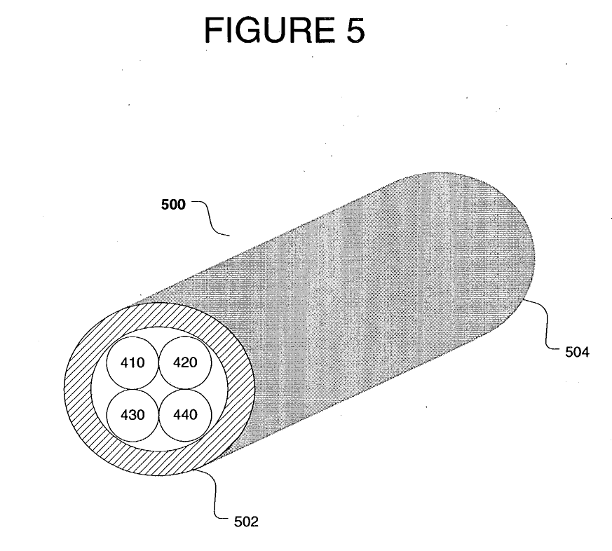

FIG. 5 is an illustration of a UTP cable in accordance with embodiments of the present invention. As illustrated, the twisted pairs of FIG. 4 are bundled into cable 500. For example, twisted pair 410 may start with “Twist Rate A” at cable end 502 and cycling sequentially through the different twist rates as it proceeds towards cable end 504; twisted pair 420 may start with “Twist Rate B” at cable end 502 and cycling sequentially through the different twist rates as it proceeds towards cable end 504; twisted pair 430 may start with “Twist Rate C” at cable end 502 and cycling sequentially through the different twist rates as it proceeds towards cable end 504; and twisted pair 440 may start with “Twist Rate D” at cable end 502 and cycling sequentially through the different twist rates as it proceeds towards cable end 504. At cable end 504, approximately equal amounts of each twist rate has been applied to each twisted pair thereby resulting in approximately equal length conductors.

During the cable bundling process each length of the twisted pair conductor may be cut and aligned at the beginning of the assembly (i.e., at 502) such that each twisted pair is offset physically to prevent two identical twist rates from lying directly alongside one another through the assembly length. This ensures that as the twist rate changes in one pair it sits near one of the other twist rates, thus minimizing crosstalk. However, at the end of a given length of the cable bundle, i.e. 504, the electrical length of the cable is approximately the same since all four pairs have the same number and rate of twist rates included within their span.

Thus, a cable for minimizing skew delay and cross talk during the transmission of analog and digital signals has been described. The claims, however, and the full scope of any equivalent define the invention.

What is claimed is:

1. A cable for minimizing skew delay and crosstalk comprising:
a cable bundle having a first end and a second end;
a plurality of conductors in said cable bundle; and
a pair of wires in each of said plurality of conductors, wherein said pair of wires has approximately equal lengths and is twisted together using a plurality of twist rates.

2. The cable of claim 1, wherein each of said plurality of twist rates is applied at uniform interval between said first end and said second end of said cable bundle.

3. The cable of claim 1, wherein each of said plurality of twist rates is distinct.

4. The cable of claim 1, wherein said plurality of twist rates is equal in number to said plurality of conductors.

5. The cable of claim 1, wherein said cable bundle has an outside protective layer around said plurality of conductors.

6. The cable of claim 1, wherein said plurality of conductors comprises:
a first conductor;
a second conductor;
a third conductor; and
a fourth conductor.

7. The cable of claim 6, wherein said plurality of twist rates comprises:
a first twist rate;
a second twist rate;
a third twist rate; and
a fourth twist rate.

8. The cable of claim 7, wherein said twisted together using a plurality of twist rates comprises:
said first conductor starting at said first end of said cable bundle with said first twist rate and sequentially cycling through said plurality of twist rates up to said second end of said cable bundle;
said second conductor starting at said first end of said cable bundle with said second twist rate and sequentially cycling through said plurality of twist rates up to said second end of said cable bundle;
said third conductor starting at said first end of said cable bundle with said third twist rate and sequentially cycling through said plurality of twist rates up to said second end of said cable bundle; and
said fourth conductor starting at said first end of said cable bundle with said fourth twist rate and sequentially cycling through said plurality of twist rates up to said second end of said cable bundle.

9. The cable of claim 8, wherein said cycling through said plurality of twist rates comprises applying each of said plurality of twist rates for a specific interval.

10. A cable for minimizing skew delay and crosstalk comprising:
a cable bundle having a first end and a second end;
a plurality of conductors in said cable bundle; and
a pair of wires in each of said plurality of conductors, wherein said pair of wires has approximately equal lengths and is twisted together using a number of distinct twist rates equal to the number of said plurality conductors, wherein each of said distinct twist rates is applied for a specific interval to said pair of wires.

11. A method for minimizing skew delay and crosstalk in a cable comprising:
using a plurality of twist rates to twist together a pair of wires having approximately equal lengths to form a conductor; and
packaging a plurality of said conductors to form a cable bundle having a first end and a second end.

12. The method of claim 11, wherein each of said plurality of twist rates is applied at uniform interval between said first end and said second end of said cable bundle.

13. The method of claim 11, wherein each of said plurality of twist rates is distinct.

14. The method of claim 11, wherein said plurality of twist rates is equal in number to said plurality of conductors.

15. The method of claim 11, wherein said cable bundle has an outside protective layer around said plurality of conductors.

16. The method of claim 11, wherein said plurality of conductors comprises:
a first conductor;
a second conductor;
a third conductor; and
a fourth conductor.

17. The method of claim 16, wherein said plurality of twist rates comprises:
a first twist rate;
a second twist rate;
a third twist rate; and
a fourth twist rate.

18. The method of claim 17, wherein said using a plurality of twist rates to form said conductor comprises:
generating said first conductor by starting at said first end of said cable bundle with said first twist rate and sequentially cycling through said plurality of twist rates up to said second end of said cable bundle;
generating said second conductor by starting at said first end of said cable bundle with said second twist rate and sequentially cycling through said plurality of twist rates up to said second end of said cable bundle;
generating said third conductor by starting at said first end of said cable bundle with said third twist rate and sequentially cycling through said plurality of twist rates up to said second end of said cable bundle; and
generating said fourth conductor by starting at said first end of said cable bundle with said fourth twist rate and sequentially cycling through said plurality of twist rates up to said second end of said cable bundle.

19. The method of claim 18, wherein said cycling through said plurality of twist rates comprises applying each of said plurality of twist rates for a specific interval.
